(19) United States
(12) Patent Application Publication
(10) Pub. No.: US 2026/0103035 A1
(43) Pub. Date: Apr. 16, 2026

(54) COUPLING UNIT

(71) Applicant: Zoltán Polyák, Kecskemét (HU)

(72) Inventor: Zoltán Polyák, Kecskemét (HU)

(73) Assignee: ACPS Automotive GmbH, Ingersheim (DE)

(21) Appl. No.: 19/421,106

(22) Filed: Dec. 16, 2025

Related U.S. Application Data
(63) Continuation of application No. PCT/EP2023/067498, filed on Jun. 27, 2023.

(51) Int. Cl. B60D 1/48

(52) U.S. Cl. CPC B60D 1/485

(57) ABSTRACT

The invention refers to a coupling unit for vehicles, comprising a cross member to be mounted on a rear region of a vehicle body by body mounts, which are attachable to said rear region of said vehicle body and a connecting element fixed to said cross member and being adapted to carry a coupling element for coupling a trailer or a load carrier to said vehicle body for achieving improved stability, said cross member comprises two carrier elements extending between said body mounts and arranged subsequently with respect to each other in a X-direction of said coupling unit for supporting the connecting element by central sections thereof and that said carrier elements have a cross section with an extension in a Z-direction of said coupling unit which amounts to at least five times, preferably at least ten times, of the extension of said cross section of said carrier elements in X-direction.

### CROSS-REFERENCE TO RELATED PATENT APPLICATION

This application is a continuation of international application number PCT/EP2023/067498 filed on 27 Jun. 2023.

The present disclosure relates to the subject matter disclosed in international application number PCT/EP2023/067498 of 27 Jun. 2023, which is incorporated herein by reference in its entirety and for all purposes.

### BACKGROUND OF THE INVENTION

The invention refers to a coupling unit for vehicles, comprising a cross member to be mounted on a rear region of a vehicle body by body mounts, which are attachable to said rear region of said vehicle body and a connecting element fixed to said cross member and being adapted to carry a coupling element for coupling a trailer or a load carrier to said vehicle body.

Such kind of coupling units are known in prior art.

In accordance with an embodiment of the invention, a coupling unit is provided having a simple design concept for the body mounts and the cross member in combination with sufficient stiffness and stability for receiving the loads intended to act on the coupling element.

### SUMMARY OF THE INVENTION

In accordance with an embodiment of the invention, a cross member is provided which comprises two carrier elements extended between said body mounts and arranged subsequently with respect to each other in an X-direction of said coupling unit for supporting the connecting element by central sections thereof and provision is made that said carrier elements have a cross section with an extension in a Z-direction of said coupling unit which amounts to at least five times, preferably at least ten times, of the extension of said cross section of said carrier elements in X-direction.

The advantage of the present invention has to be seen in the fact that the design of said carrier elements is on one hand simple and due to the extension in Z-direction stable enough for receiving the loads intended to act on the coupling element and on the other hand this design due to the limited extension in X-direction of said carrier elements is able to be adapted to small spaces available below a rear bumper unit of said vehicle.

In order to reduce the space necessary for said cross member in X-direction of said coupling unit a preferred design provides that at least one of said carrier elements is a flat bar and that said flat bar is provided with at least one flat surface extending essentially in Z-direction of said coupling unit, so that the dimensions of the cross section said flat bar in X-direction are smaller than in case tubes or other elements would be used.

It is even more advantageous, if both carrier elements are made of flat bars with both carrier elements with their flat surfaces extend essentially in Z-direction of said coupling unit.

According to the previous definitions of the shape of said carrier elements it would be possible to have both carrier elements provided with a flat surface whereas the opposite surface of said flat elements could be different from a flat surface, such for example curved in cross section or provided with the beads or corrugations or crimps.

In order to provide a very simple design it is of advantage if both flat bars have flat surfaces on opposite sides thereof.

However, the flat surfaces on opposite sides could extend at an angle with respect to each other which deviates from a parallel extension.

Therefore, the most simple design provides that both flat bars with their flat surfaces extend essentially parallel to each other.

The foregoing definitions of said shape of said flat bars also include that one of the flat bars with its flat surface could extend at an angle greater than 0° to the flat surface of the other of said flat bars.

However, the space necessary for said cross member can be reduced if each of said two flat bars has a flat surface which extends at an angle of less than 20° relative to the flat surface of the other flat bar.

It is even more advantageous if said flat surfaces of said flat bars extend essentially parallel to the Z-direction of said coupling unit.

The term “essentially” as used in the definitions given in this application is intended to comprise all deviations from a parallel orientation up to an angle of less than 15°, even better up to an angle of less than 10°.

According to the present invention the design of said flat bars provides that each flat bar is provided with at least on flat surface which extends transvers to its longitudinal direction over a distance which is greater than 10 times of the thickness of said flat bar.

In particular said flat bar is a massive part having a thickness of at least 3 mm.

In order to provide a simple connection to said body mounts the carrier elements are provided with mounting sections which a fixed to said body mounts.

In particular it is of advantage if said mounting sections of said carrier elements are fixed to said body mounts by screw connections.

Such screw connections enable an easy mounting of said carrier elements to said body mounts and in particular enable an easy connection of said carrier elements to said body mounts in the course of mounting said coupling unit to the vehicle so that the coupling unit can be sold to a customer without the body mounts being connected to said carrier elements.

In order to simplify mounting of said mounting sections of said carrier elements to said body mounts it is provided that said body mounts comprise a fixing portion extending in Y-direction of said coupling unit so that said carrier element which also extend in Y-direction of said coupling unit can be easily fixed, in particular by abutting with their flat surfaces on said fixing portions.

In order to provide a simple assembly of the coupling unit according to the present invention it is provided that said carrier elements are fixed to said connecting element, in particular by screw connections.

In order to increase the stability of the cross member an advantageous solution provides that said carrier elements are provided with central sections which extend at a distance from each other for receiving the connecting element between them.

This solution has the advantage that on one hand the connecting element can be fixed to both carrier elements and on the other hand the carrier elements are provided with a stiff and stable connection with each other within their central sections so that the stability of the cross member formed by said two carrier elements is improved.

In order to further increase the stability of said two carrier elements it is provided that the two carrier elements are extending between said body mounts with the distance between the carrier elements increasing from each of that body mounts towards the central section of said carrier elements so that the maximum distance between said carrier elements exists at the central sections of said carrier elements and the minimum distance between said carrier elements exists at said body mounts in particular at the mounting sections of said carrier elements connected to said body mounts.

A further advantageous solution provides that said two carrier elements with their flat surfaces limit a free space between said carrier elements wherein in particular said free space extends between said central sections and beyond said central sections in direction towards said mounting sections.

The design according to the present invention further has the advantage that said free space is open in Z-direction of said coupling unit at least towards the road surface enabling mounting of said connection unit between said carrier elements, a feature which also facilitates assembly of said coupling unit at the time it is mounted to the vehicle.

In particular it is of advantage if said free space between said carrier elements is designed such that said connecting element can be inserted into said free space from at least one of its open sides.

In particular it is of advantage if said connecting element together with said coupling element and in particular the bearing unit mounted thereon can be inserted into said free space from at least one of its open sides.

It is further of particular advantage if said at least one open side formed between said carrier elements extends in Y-direction of said coupling unit.

In order to further increase the stability of said cross member it is further provided that said carrier elements are connected to each other in lateral sections thereof extending between said body mounts and said central sections by support elements connecting said carrier elements.

In particular said support elements are connected to said carrier elements by screw connections which also facilitate assembly of said coupling unit in particular by a user when mounting it to the vehicle.

According to the present invention there are different designs referring to the connection of the coupling element to the connecting element.

For example one design provides that said connecting element for carrying said coupling element carries a housing with a receptacle for receiving a removeable mounting section of said coupling element and further a locking system for fixing said removeable mounting section to said housing is provided which locking system can be either provided in said housing or in said removeable mounting section of said coupling element.

Another advantageous solution provides that said connecting element carries a bearing unit for said coupling element said bearing unit being fixed to said connecting element and enables movement of said coupling element between a working position in which said coupling element extends essentially parallel to said X-direction and a rest position in which said coupling element extends transverse to said X-direction and that Z-direction.

A further advantageous solution provides that said coupling element in said rest position is received in the free space between said carrier elements so that said free space enables to arrange said coupling element in a rest position which is invisible from behind the vehicle and in an optimized space saving position of said coupling unit.

With respect to movement of said coupling element between the working position and the rest position no further details have given so far.

One advantageous solution provides that a bearing unit enables rotation of said coupling element with respect to said connection element about at least one pivot axis.

In the embodiments explained so far no details have been given to an advantageous design of the connecting element.

One such design comprises flange elements abutting on said central sections of said carrier elements and being fixed thereto.

Such a design enables to improve the stability of the coupling unit comprising the two carrier elements.

A further advantageous solution provides that said connecting element is provided with at least one transverse connector extending between said flange elements.

In particular such a transverse connector is designed such that said at least one transverse connector carries said bearing unit, for example by a receptacle arranged in said transverse connector.

An alternative design provides that said connecting element comprises to transverse bodies connecting said central sections.

Advantageously said transverse bodies are screw connected to said central sections for providing easy assembly.

In particular said transverse bodies comprise bearing flanges receiving said bearing unit.

Further embodiments and advantages of the present invention are subject matter of the following detailed specification and the drawings.

In particular, advantageous embodiments of the invention can comprise the combination of features as defined by the following consecutively numbered features.

Feature 1. Coupling unit (20) for vehicles (10), comprising a cross member (22) to be mounted on a rear region (14) of a vehicle body (12) by body mounts (24), which are attachable to said rear region (14) of said vehicle body (12) and a connecting element (30) fixed to said cross member (22) and being adapted to carry a coupling element (40) for coupling a trailer or a load carrier to said vehicle body (12), wherein that said cross member (22) comprises two carrier elements (52, 54) extending between said body mounts (24) and arranged subsequently with respect to each other in a X-direction of said coupling unit (20) for supporting the connecting element (30) by central sections (102, 104) thereof and that said carrier elements (52, 54) have a cross section with an extension in a Z-direction of said coupling unit (20) which amounts to at least five times, preferably at least ten times, of the extension of said cross section of said carrier elements (52, 54) in X-direction.

Feature 2. Coupling unit (20) according to feature 1, wherein said at least one of said carrier elements (52, 54) is a flat bar and that said flat bar is provided with at least one flat surface (62, 66) extending essentially in Z-direction of said coupling unit (20).

Feature 3. Coupling unit (20) according to feature 1, wherein said both carrier elements (52, 54) are made of flat bars and both carrier elements (52, 54) with their flat surfaces (62, 66) extend essentially in Z-direction of said coupling unit (20).

Feature 4. Coupling unit (20) according to features 2 or 3, wherein said both flat bars (52, 54) have flat surfaces (62, 64, 66 68) on opposite sides thereof.

Feature 5. Coupling unit (20) according to feature 4, wherein said both flat bars (52, 54) with their flat surfaces (62, 64, 66, 68) extend essentially parallel to each other.

Feature 6. Coupling unit (20) according to one of the preceding features, wherein said each of said two flat bars (52, 54) has a flat surface (62, 66) which extends at an angle of less than 20° relative to the flat surface (62, 66) of said other flat bar (52, 54).

Feature 7. Coupling unit (20) according to one of the preceding features, wherein said flat surfaces (62, 64, 66, 68) of said flat bars (52, 54) extend essentially parallel to the Z-direction of said coupling unit (20).

Feature 8. Coupling unit (20) according to one of features 3 to 7, wherein said each flat bar (52, 54) is provided with at least one flat surface (62, 66) which extends transverse to its longitudinal direction over a distance which is greater than ten times, of the thickness of said flat bar (52, 54).

Feature 9. Coupling unit (20) according to one of the preceding features, wherein the carrier elements (52, 54) are provided with mounting sections (82, 84, 86, 88) which are fixed to said body mounts (24).

Feature 10. Coupling unit (20) according to feature 9, wherein said mounting sections (82, 84, 86, 88) of said carrier elements (52, 54) are fixed to said body mounts (24) by screw connections (92).

Feature 11. Coupling unit (20) according to feature 10, wherein said body mounts (24) comprise a fixing portion (74) extending into Y-direction of said coupling unit (20).

Feature 12. Coupling unit (20) according to one of features 9 to 11, wherein said body mounts (24) with their mounting portions (72) extend essentially parallel to said X-direction of said coupling unit (20).

Feature 13. Coupling unit (20) according to features 11 or 12, wherein said flat bars (52, 54) are abutting with their flat surfaces (64, 66) on said fixing portions (74) of said body mounts (24).

Feature 14. Coupling unit (20) according to one of the preceding features, wherein said carrier elements (52, 54) are fixed to said connecting element (30).

Feature 15. Coupling unit (20) according to feature 14, wherein said carrier elements (52, 54) are fixed to said connecting element (30) by screw connections (156, 158).

Feature 16. Coupling unit (20) according to one of the preceding features, wherein said carrier elements (52, 54) are provided with central sections (102, 104) which extend at a distance from each other for receiving the connecting element (30) between them.

Feature 17. Coupling unit (20) according to one of the preceding features, wherein the two carrier elements (52, 54) are extending between said body mounts (24) with the distance between said carrier elements (52, 54) increasing from each said body mounts (24) towards the central section (102, 104) of said carrier elements (52, 54).

Feature 18. Coupling unit (20) according to one of the preceding features, wherein said two carrier elements (52, 54) with their flat surfaces (62, 64) limit a free space (120) between said carrier elements (52, 54), wherein in particular said free space (120) extends between said central sections (102, 104) and beyond said central sections (102, 104) in direction towards said mounting sections (82, 84, 86, 88).

Feature 19. Coupling unit (20) according to feature 18, wherein said free space (120) is open in Z-direction of said coupling unit (20) at least towards the road surface.

Feature 20. Coupling unit (20) according to feature 18 or 19, wherein said free space (120) between said carrier elements (52, 54) is designed such that said connecting element (30) can be inserted into said free space (120) from at least one of its open sides.

Feature 21. Coupling unit (20) according to feature 19 or 20, wherein said connecting element (30) together with that coupling element (40) an in particular the bearing unit (164) mounted thereon can be inserted into said free space (120) from at least one of its open sides.

Feature 22. Coupling unit (20) according to feature 20 or 21, wherein said at least one open side formed by said carrier elements (52, 54) extends in Y-direction of said coupling unit (20).

Feature 23. Coupling unit (20) according to one of the preceding features, wherein said carrier elements (52, 54) are connected to each other in lateral sections (112, 114, 116, 118) thereof extending between said body mounts (24) and said central sections (102, 104) by support elements (182, 184).

Feature 24. Coupling unit (20) according to feature 23, wherein said support elements (182, 184) are connected to said carrier elements (52, 54) by screw connections (186, 188).

Feature 25. Coupling unit (20) according to one of the preceding features, wherein said connecting element (30) for carrying said coupling element (40) carries a housing (242) with a receptacle (244) for receiving a removeable mounting section (246) of said coupling element (40) and further a locking system (248) for fixing said removeable mounting section (246) to said housing (242) is provided.

Feature 26. Coupling unit (20) according to one of features 1 to 24, wherein said connecting element (30) carries a bearing unit (164) for said coupling element (40) said bearing unit (164) being fixed to said connecting element (30) and enables movement of said coupling element (40) between a working position, in which said coupling element (40) extends essentially parallel to said X-direction and a rest position, in which said coupling element (40) extends transverse to said X-direction and said Z-direction.

Feature 27. Coupling unit (20) according to feature 26, wherein said coupling element (40) in said rest position is received in the free space (120) between said carrier elements (52, 54).

Feature 28. Coupling unit (20) according to feature 26 or 27, wherein a bearing unit (164) enables rotation of said coupling element (40) with respect to said connecting element (30) about at least one pivot axis (166).

Feature 29. Coupling unit (20) according to one of the preceding features, wherein said connecting element (30) comprises flange elements (136, 138) abutting on said central sections (102, 104) of said carrier elements (52, 54) and being fixed thereto.

Feature 30. Coupling unit (20) according to feature 29, wherein said connecting element (30) is provided with at least one transverse connector (142) extending between said flange elements (136, 138).

Feature 31. Coupling unit (20) according to feature 29 to 30, wherein at least one transverse connector (142) carries said bearing unit (164).

Feature 32. Coupling unit (20) according to one of features 1 to 25, wherein said connecting element (30″) comprises two transverse bodies (192, 194) connecting said central sections (102, 104).

Feature 33. Coupling unit (20) according to feature 32, wherein said transverse bodies (192, 194) are screw connected to said central sections (102, 104).

Feature 34. Coupling unit (20) according to feature 32 or 33, wherein said transverse bodies (192, 194) comprise bearing flanges (204, 214) receiving the bearing unit (164).

### BRIEF DESCRIPTION OF THE DRAWINGS

FIG. 1 present a side view of a vehicle provided with a coupling unit according to the present invention;

FIG. 2 shows a lower rear part of the body of the vehicle together with a first embodiment of the present invention mounted thereto;

FIG. 3 shows a perspective view of a coupling unit comprising body mounts, the cross member and the coupling element connected to the cross member by a connecting element;

FIG. 4 shows a top view on the coupling unit shown in FIG. 3 with the coupling element in its working position;

FIG. 5 shows a perspective view of a connecting element according to a first embodiment together with the coupling element in its working position and the bearing unit enabling pivotal movement of the coupling unit with respect to the connecting element;

FIG. 6 shows another perspective view of the connecting element with the coupling element and the bearing unit;

FIG. 7 shows an exploding view of said coupling unit;

FIG. 8 shows a top view on said first embodiment of said coupling unit with a coupling element in its rest position;

FIG. 9 shows a second embodiment of a coupling unit according to the present invention provided with a second embodiment of a connecting element;

FIG. 10 shows a third version of a coupling unit according to the present invention with a third embodiment of a connecting unit provided for mounting a removable coupling element.

### DETAILED DESCRIPTION OF THE INVENTION

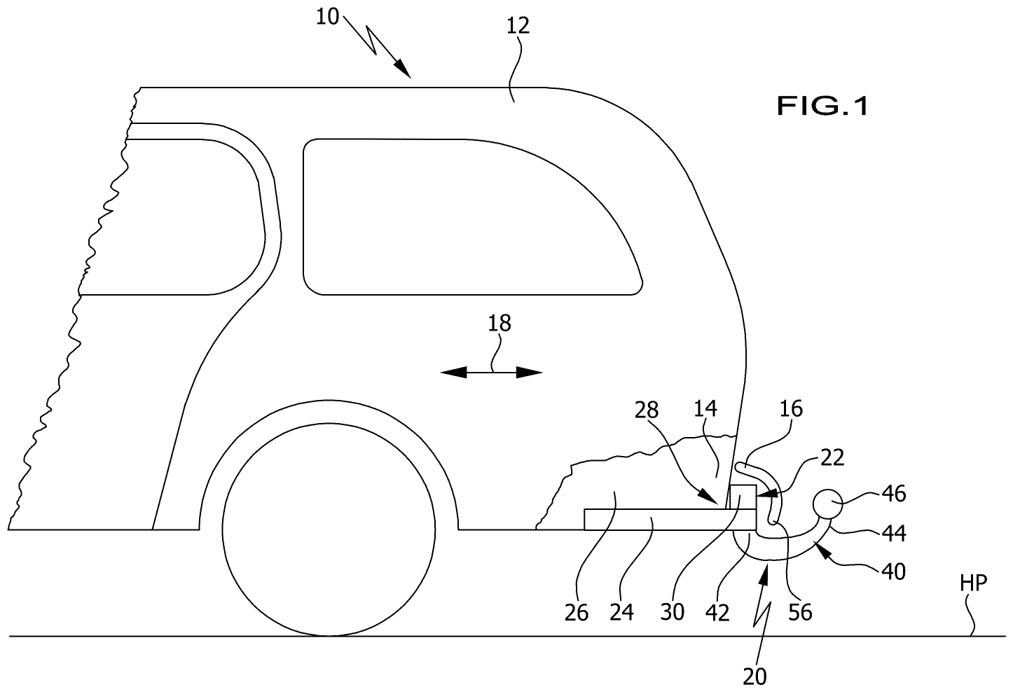

A motor vehicle 10 according to FIG. 1 comprises a vehicle body 12, on which is mounted in a lower rear region 14 a coupling unit 20 according to the invention that comprises a cross member 22, which is covered by a rear bumper unit 16 of said vehicle 10 and extends transversely to a longitudinal direction 18 of the vehicle body 12 and transversely to a vertical vehicle longitudinal center plane VVP over the rear region 14, and body mounts 24, which for example extend approximately parallel to the longitudinal direction 18 of the vehicle body 12 along body wall portions 26 and are fixed thereto and/or which abut on the rear region 14 for example by forming flanges and which, together with the cross member 22, form a carrier unit 28 that is covered partly by the vehicle body 12 and partly by the bumper unit 16.

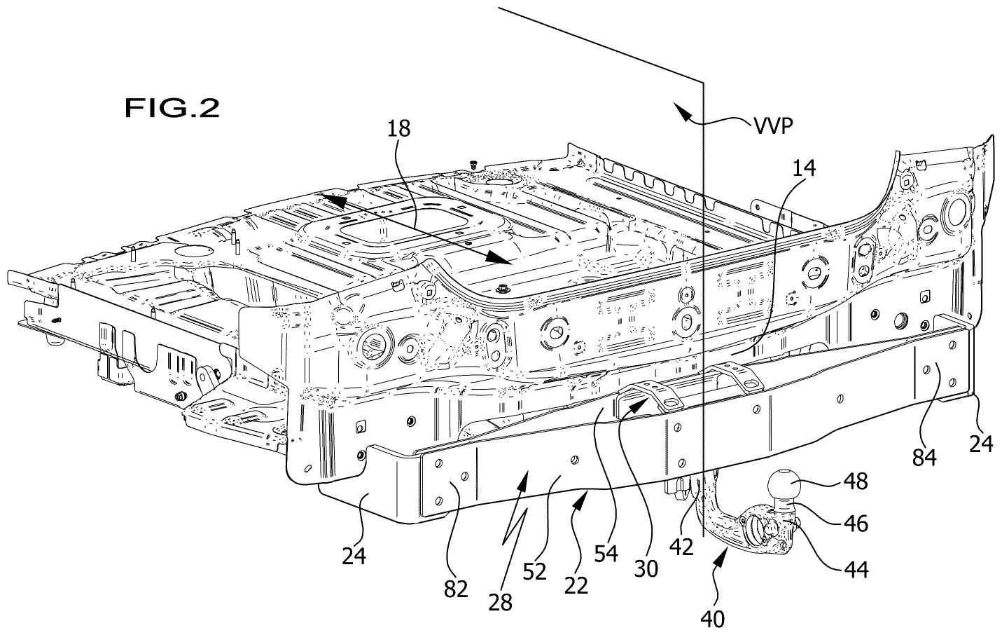

Provided on the carrier unit 28 is a connecting element 30, to which a coupling element that is designated 40 as a whole, for example a ball neck, is connected by means of a first end 42 and extending therefrom to a second end 44 at which for example a ball carrier 46 with a coupling ball 48, is connected as illustrated in FIGS. 1 and 2.

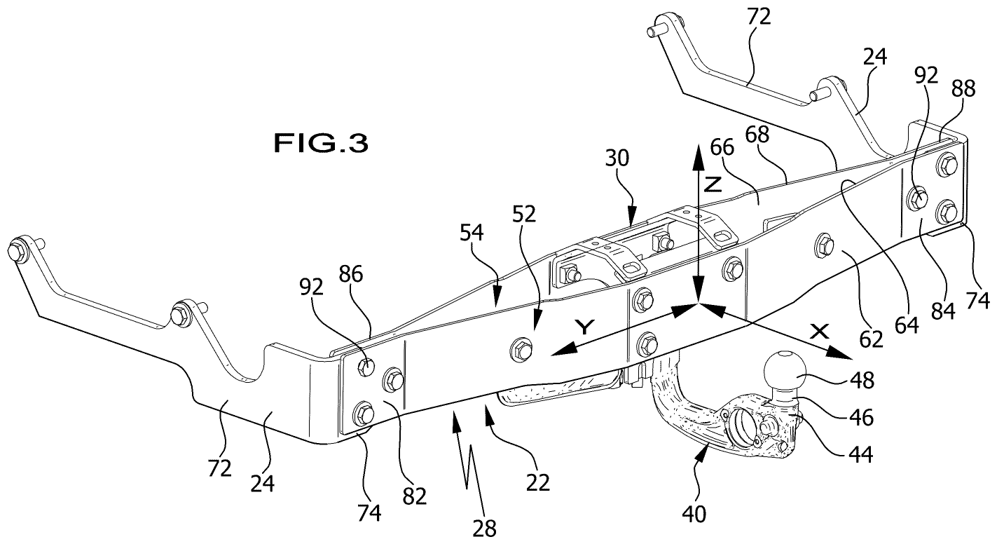

The cross member 22 as shown in FIGS. 2 and 3 comprises two carrier elements 52, 54, which with respect to each other are arranged subsequently in an X-direction of the coupling unit 20 and extend in a Y-direction of said coupling unit 20 between body mounts 24 and are both fixed to body mounts 24.

Each of carrier elements 52, 54 has an extension in Z-direction which corresponds to at least five times, better at least ten times its thickness in X-direction of said coupling unit 20.

The X-, Y- and Z-direction of said coupling unit 20 in case the coupling unit 20 is mounted to the vehicle body 12 are aligned with the longitudinal direction 18 of the vehicle body 12 and the vehicle longitudinal center plane VVP such that the X-direction extends essentially in horizontal direction and parallel to the longitudinal direction 18 in case the vehicle 10 is arranged on a horizontal plane HP representing the road.

The Y-direction is extending transverse the vehicle longitudinal center plane VVP and therefore essentially in horizontal direction transverse to the X-direction and parallel to the horizontal plane HP forming the road.

And the Z-direction is extending transverse to the X- and Y-direction and also parallel to the vertical vehicle longitudinal center plane VVP and transverse, in particular vertical, with respect to horizontal plane HP.

In a preferred embodiment carrier elements 52, 54 have the shape of a flat bar with two flat surfaces 62, 64 of carrier element 52 and flat surfaces 66, 68 of carrier element 54 which flat surfaces 62, 64 and 66, 68 are extending essentially parallel to each other and essentially parallel to the Z-direction.

For connecting the cross member 28 with the body mounts 24 each body mount 24 comprises a mounting portion 72 fixed to the respective body wall portion 26 of vehicle body 12 and a fixing portion 74 which extends transverse to said mounting portion 72 and essentially parallel to the Y-direction so that carrier elements 52, 54 with their respective mounting sections 82, 84 and 86, 88 respectively are abutting on opposite sides of said fixing portions 74 and connected therewith for example by screw connections 92 which screw connections 92 enable an easy assembly of the carrier unit 28 and body mounts 24.

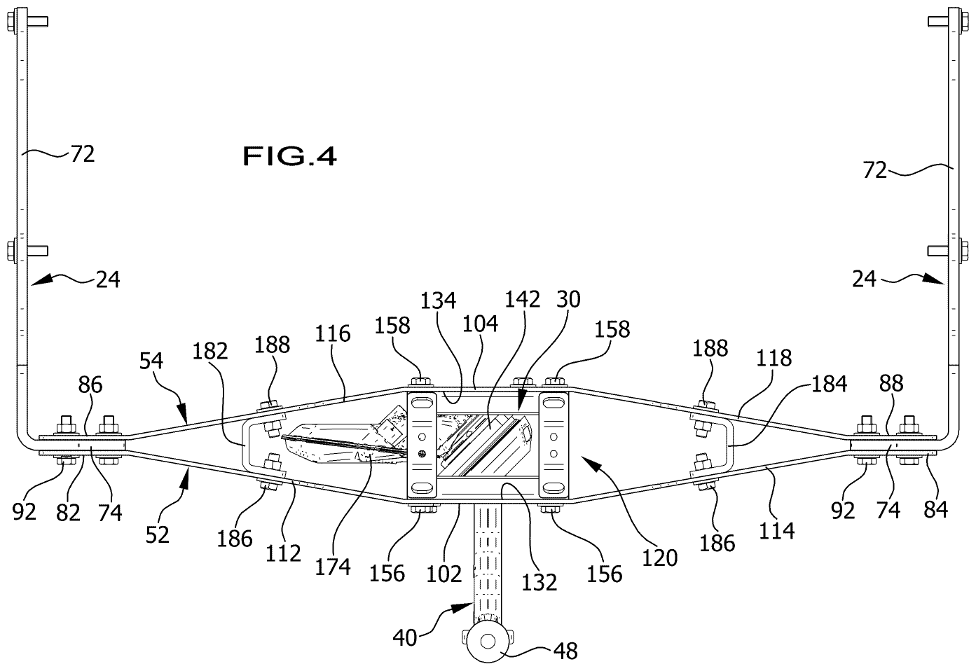

As can be best seen in FIG. 4 the two carrier elements 52, 54 comprise central sections 102, 104 arranged in the middle between mounting sections 82 and 84 as well as 86 and 88 respectively which central sections 102, 104 extend essentially parallel to each other.

Further carrier elements 52, 54 when starting from their mounting sections 82, 84 or 86, 88 and extending towards central sections 102, 104 are provided with lateral sections 112, 114 and 116, 118 respectively which extend from the mounting sections 82, 84 or 86, 88 with increasing distance with respect to each other to the central sections 102, 104 such that a free space 120 is formed between central sections 102 and 104 as well as lateral sections 112, 114 and lateral sections 116, 118.

In this free space a connecting element 30 is arranged which extends between central sections 102 and 104 and connects central sections 102 and 104 of carrier elements 52, 54 by abutting on inner sides 132, 134 of carrier elements 52, 54 with flange elements 136, 138 which are supported with respect to each other by transverse connectors 142 as well as 144 and 146.

In particular the flange elements 136, 138 are stabilized with respect to each other by transverse connectors 142, 144 and 146 on their outer sides in Y-direction in order to provide a stabilization of central sections 102, 104 of carrier elements 52, 54 on there lateral outer sides.

Further transverse connectors 142, 144 and 146 are arranged such that they also stabilize flange elements 136, 138 on their upper and lower sides, when seen in Z-direction, in order to stabilize central sections 102 and 104 of carrier elements 52, 54 on their upper sides as well as on their lower sides.

According to a preferred embodiment flange elements 136, 138 and transverse connectors 142, 144, 148 are fixed with respect to each other by welding seams 152 in case of transverse connector 142 as well as welding seams 154 in case of transverse connectors 144, 146 so that flange elements 136, 138 together with transfer connectors 142, 144, 146 are forming a stiff connecting unit 30 stabilizing central sections 102 and 104 of carrier elements 52, 54 in all directions X, Y and Z with respect to each other in order to obtain the carrier unit 20 with the necessary stability.

Preferably connecting element 30 is fixed to central sections 102 and 104 by screw connections 156 and 158 which enable easy assembly of carrier elements 52, 54 and connecting element 30 whereas connecting element 30 welding connections between flange elements 136 and 138 as well as transverse elements 142, 144, 146, all connected by welding seams 152, 154, represents a preformed part for being assembled with carrier elements 52, 54 by the screw connections 156, 158.

Preferably, each of central sections 102 and 104 is connected to the respective flange element 136, 138 by at least three screw connections, in this case two screw connections 156, 158 respectively on the upper side and one screw connection 156, 158 respectively on the lower side.

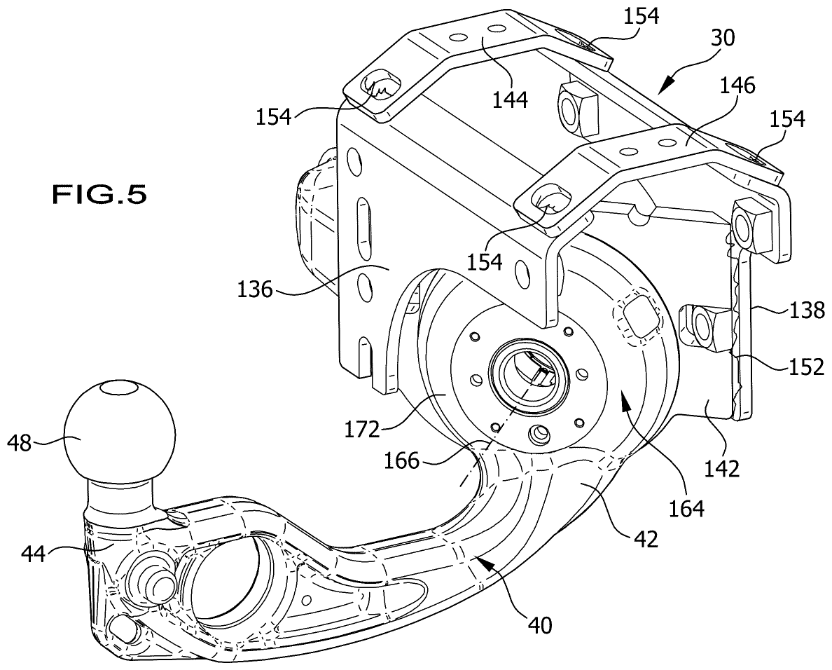

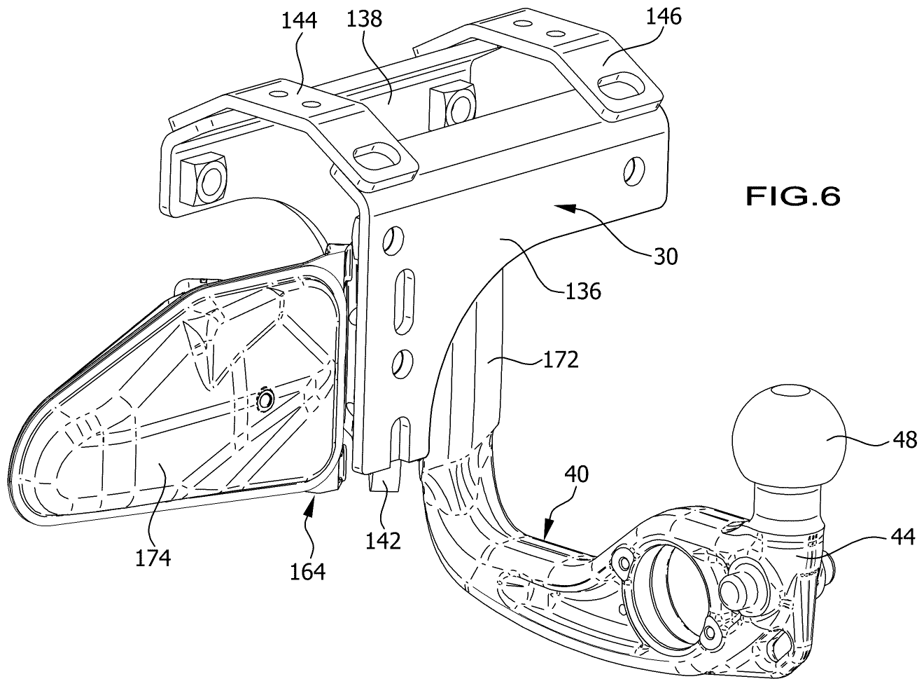

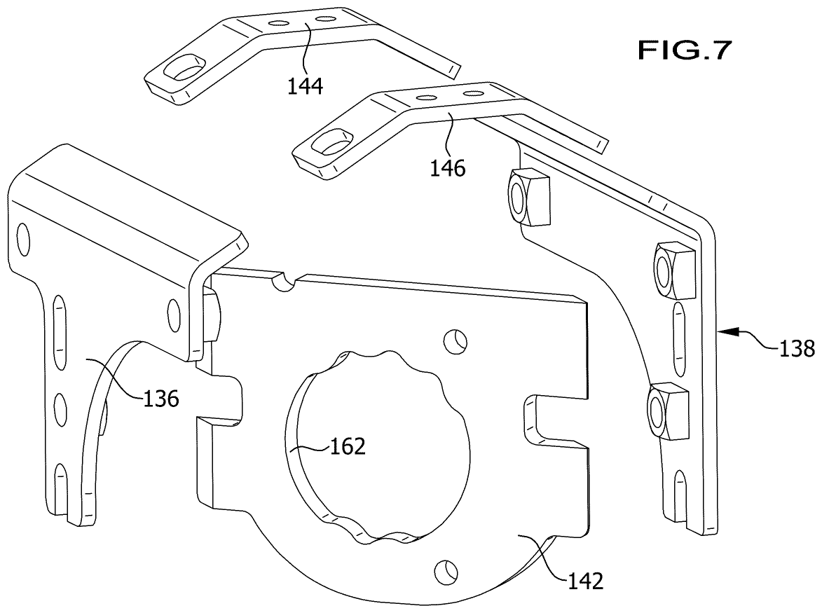

In the embodiment according to FIG. 3 to 8 transverse element 142 is extending between flange elements 136, 138 at an inclined angle and is provided with an opening 162 in order to receive a bearing unit 164 enabling pivoting of coupling element 40 about a pivot axis 166 between a working position, shown in FIG. 3, and a rest position.

For example bearing unit 164 extends on both sides of plate like transverse element 142, in particular on one side with its pivotable body 172 to which first end 42 of coupling element 40 is fixed, and on the other side, shown for example in FIGS. 4, 5 and 8 with a drive and gear unit 174 which extends between lateral sections 112 and 116 of carrier elements 52, 54 within receiving space 120.

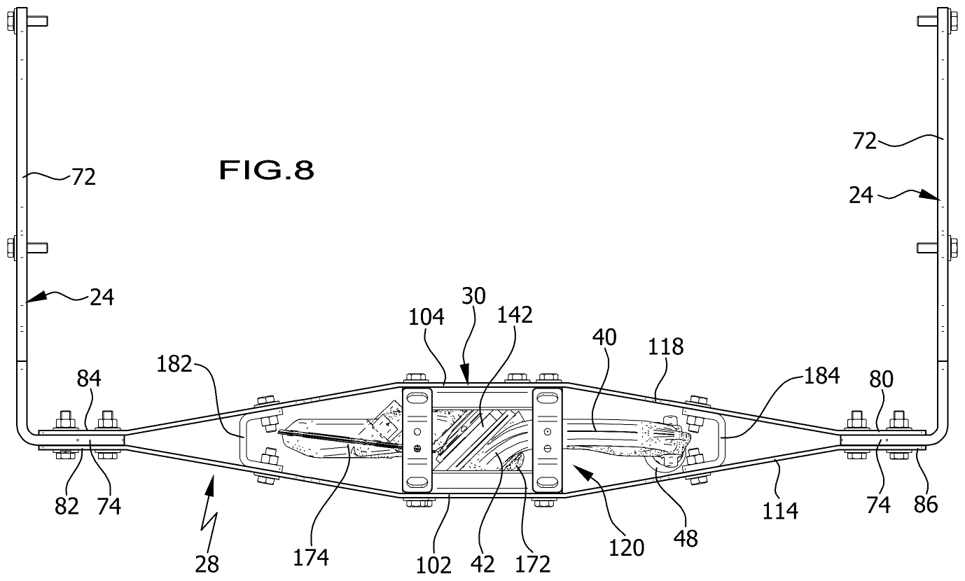

According to this embodiment the coupling element 140 can be pivoted about pivot axis 166 from its working position into a rest position shown in FIG. 8, in which coupling element 40 is arranged within receiving section 120 between lateral sections 114 and 118 with the coupling ball 48 arranged below coupling element 40.

For additional support between lateral sections 112, 116 as well as lateral sections 114 and 118 support elements 182 and 184 are extending between lateral sections 112 and 116 and lateral sections 114 and 118 which for example are a C-shaped and are connected to lateral sections 112 and 114 by screw element 186 and to lateral sections 116 and 118 by screw element 188.

In order to provide optimized conditions for using receiving space 120 support elements 182 and 184 are arranged in such a distance from connecting element 30 that they are arranged between coupling element 40 in its rest position and gear unit 174.

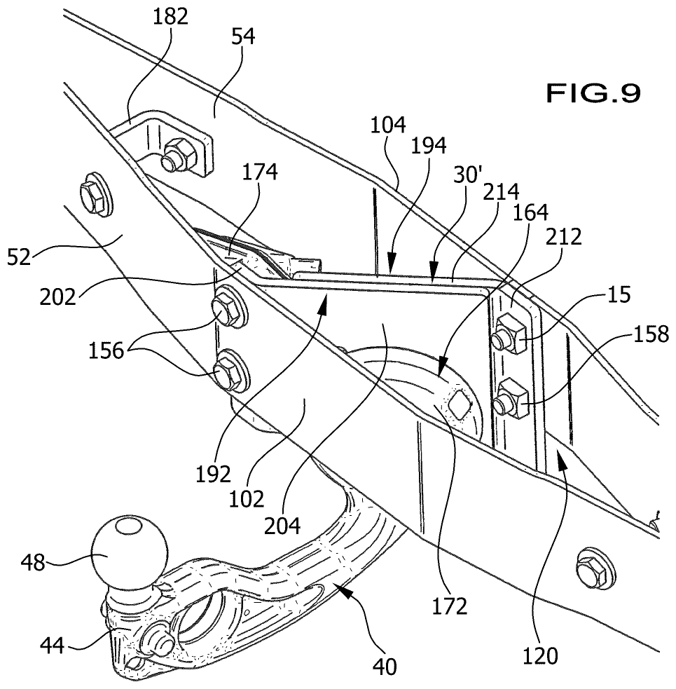

A further embodiment shown in FIG. 9 uses the same design of carrier elements 52 and 54 as well as body mounts 24 however in order to provide a simplified version connecting element 30′ only comprises two transverse bodies 192, 194.

Transverse body 192 comprises a connecting flange 202 fixed to central section 102 by an upper and a lower screw connection 156 and a bearing flange 204 extending at an inclined angle with respect to central section 102.

Transverse body 194 comprises a connecting flange 212 screw connected by an upper and a lower screw connection 158 to central section 104 and a bearing flange 214 extending at an inclined angle with respect to central section 104 and parallel to bearing flange 204 so that bearing flanges 204 and 214 are abutting on each other and both receive bearing unit 164 for pivotable mounting of coupling element 40 in the same manner as disclosed in connection with the first embodiment. In particular bearing unit 164 when received by bearing flanges 204 and 214 can also maintain bearing flanges 204 and 214 abutting on each other.

The advantage of this embodiment is that assembly of the connecting element 30′ can take place at the time of assembly of all components of coupling unit 20 for example at the time before mounting it to the vehicle 10.

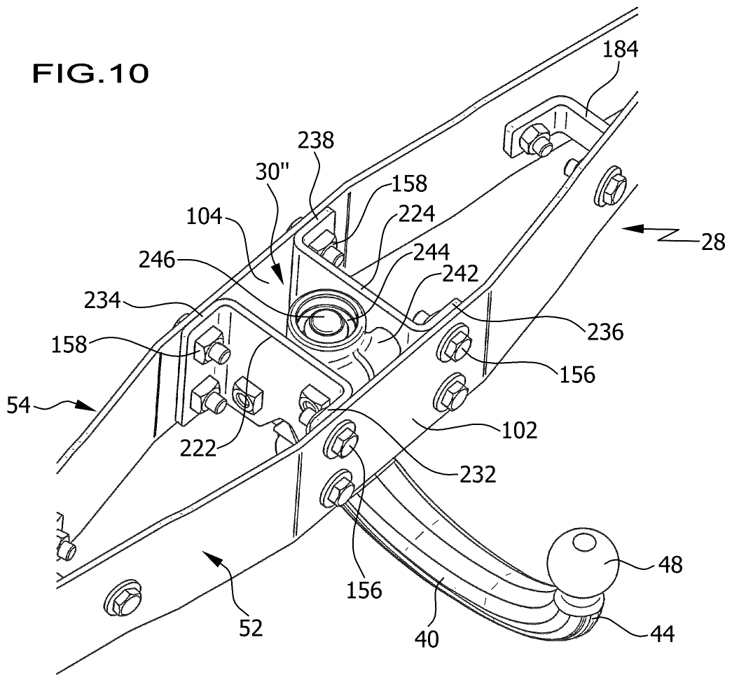

According to a further embodiment, shown in FIG. 10 carrier elements 52 and 54 have the identical design as explained in connection with the previous embodiments.

In particular central sections 102 and 104 are of the same design as explained before.

In contrast to the previous embodiment coupling element 30″ comprises two transverse elements 222, 224 arranged at a distance between each other and extending from central section 102 to central section 104 and having mounting flanges 232 and 234 as well as 236 and 238 for fixing them to central section 102 and central section 104 by screw connections 156 and 158 in order to fix and to stabilize central sections 102 and 104 with respect to each other.

In addition, transverse elements 222, 224 receive a housing 242 arranged between them which is also screw connected to transverse element 222 as well as transverse element 224 and has a receptacle 244 in which a removeable mounting section 246 of coupling element 40 can be inserted and fixed so that coupling element 40 together with its mounting element can be removed from housing 242 in case of non-use, whereas for use mounting section 246 is inserted into receptacle 244 and locked by a locking system 248 provided in said mounting section 246 or in said housing 242 in order to fix coupling element 40 with respect to connecting element 30″ against removal and rotation.

According to this embodiment assembly of the components of coupling element 30″ can take place at the time of assembly of all other components of the coupling unit, for example immediately before mounting it to the vehicle 10.

1. A coupling unit for vehicles, comprising a cross member to be mounted on a rear region of a vehicle body by body mounts, which are attachable to said rear region of said vehicle body and a connecting element fixed to said cross member and being adapted to carry a coupling element for coupling a trailer or a load carrier to said vehicle body,
wherein said cross member comprises two carrier elements extending between said body mounts and arranged subsequently with respect to each other in a X-direction of said coupling unit for supporting the connecting element by central sections thereof and wherein said carrier elements have a cross section with an extension in a Z-direction of said coupling unit which amounts to at least five times, preferably at least ten times, of the extension of said cross section of said carrier elements in X-direction.

2. The coupling unit according to claim 1, wherein at least one of said carrier elements is a flat bar and wherein said flat bar is provided with at least one flat surface extending essentially in Z-direction of said coupling unit.

3. The coupling unit according to claim 1, wherein both carrier elements are made of flat bars and both carrier elements with their flat surfaces extend essentially in Z-direction of said coupling unit.

4. The coupling unit according to claim 2, wherein both flat bars have flat surfaces on opposite sides thereof.

5. The coupling unit according to claim 4, wherein both flat bars with their flat surfaces extend essentially parallel to each other.

6. The coupling unit according to claim 1, wherein each of said two flat bars has a flat surface which extends at an angle of less than 20° relative to the flat surface of said other flat bar.

7. The coupling unit according to claim 1, wherein said flat surfaces of said flat bars extend essentially parallel to the Z-direction of said coupling unit.

8. The coupling unit according to claim 3, wherein each flat bar is provided with at least one flat surface which extends transverse to its longitudinal direction over a distance which is greater than ten times, of the thickness of said flat bar.

9. The coupling unit according to claim 1, wherein the carrier elements are provided with mounting sections which are fixed to said body mounts.

10. The coupling unit according to claim 9, wherein said mounting sections of said carrier elements are fixed to said body mounts by screw connections.

11. The coupling unit according to claim 10, wherein said body mounts comprise a fixing portion extending into Y-direction of said coupling unit.

12. The coupling unit according to claim 9, wherein said body mounts with their mounting portions extend essentially parallel to said X-direction of said coupling unit.

13. The coupling unit according to claim 11, wherein said flat bars are abutting with their flat surfaces on said fixing portions of said body mounts.

14. The coupling unit according to claim 1, wherein said carrier elements are fixed to said connecting element.

15. The coupling unit according to claim 14, wherein said carrier elements are fixed to said connecting element by screw connections.

16. The coupling unit according to claim 1, wherein said carrier elements are provided with central sections which extend at a distance from each other for receiving the connecting element between them.

17. The coupling unit according to claim 1, wherein the two carrier elements are extending between said body mounts with the distance between said carrier elements increasing from each said body mounts towards the central section of said carrier elements.

18. The coupling unit according to claim 1, wherein said two carrier elements with their flat surfaces limit a free space between said carrier elements, wherein in particular said free space extends between said central sections and beyond said central sections in direction towards said mounting sections.

19. The coupling unit according to claim 18, wherein said free space is open in Z-direction of said coupling unit at least towards the road surface.

20. The coupling unit according to claim 18, wherein said free space between said carrier elements is designed such that said connecting element can be inserted into said free space from at least one of its open sides.

21. The coupling unit according to claim 19, wherein said connecting element together with that coupling element an in particular the bearing unit mounted thereon can be inserted into said free space from at least one of its open sides.

22. The coupling unit according to claim 20, wherein said at least one open side formed by said carrier elements extends in Y-direction of said coupling unit.

23. The coupling unit according to claim 1, wherein said carrier elements are connected to each other in lateral sections thereof extending between said body mounts and said central sections by support elements.

24. The coupling unit according to claim 23, wherein said support elements are connected to said carrier elements by screw connections.

25. The coupling unit according to claim 1, wherein said connecting element for carrying said coupling element carries a housing with a receptacle for receiving a removeable mounting section of said coupling element and further a locking system for fixing said removeable mounting section to said housing is provided.

26. The coupling unit according to claim 1, wherein said connecting element carries a bearing unit for said coupling element said bearing unit being fixed to said connecting element and enables movement of said coupling element between a working position, in which said coupling element extends essentially parallel to said X-direction and a rest position, in which said coupling element extends transverse to said X-direction and said Z-direction.

27. The coupling unit according to claim 26, wherein said coupling element in said rest position is received in the free space between said carrier elements.

28. The coupling unit according to claim 26, wherein a bearing unit enables rotation of said coupling element with respect to said connecting element about at least one pivot axis.

29. The coupling unit according to claim 1, wherein said connecting element comprises flange elements abutting on said central sections of said carrier elements and being fixed thereto.

30. The coupling unit according to claim 29, wherein said connecting element is provided with at least one transverse connector extending between said flange elements.

31. The coupling unit according to claim 29, wherein at least one transverse connector carries said bearing unit.

32. The coupling unit according to claim 1, wherein said connecting element comprises two transverse bodies connecting said central sections.

33. The coupling unit according to claim 32, wherein said transverse bodies are screw connected to said central sections.

34. The coupling unit according to claim 32, wherein said transverse bodies comprise bearing flanges receiving the bearing unit.
